(19) United States
(12) Patent Application Publication
(10) Pub. No.: US 2005/0112270 A1
(43) Pub. Date: May 26, 2005

(54) Sweet potato composition and method of making thereof

(76) Inventor: Myrtle Lee Mims, Albany, NY (US)

Correspondence Address: ARLEN L. OLSEN;SCHMEISER, OLSEN & WATTS, 3 LEAR JET LANE, SUITE 201, LATHAM, NY, 12110, US

(21) Appl. No.: 10/720,508

(22) Filed: Nov. 24, 2003

(51) Int. Cl. A23L 1/216

(52) U.S. Cl. 426/637

(57) ABSTRACT

The present invention provides a method of making an edible sweet potato composition, comprising: providing a first mixture that includes sweet potato; and forming the edible sweet potato composition, having a mouthfeel in a range of preferably from about 5.1 to about 9.0, based on a mouthfeel test, wherein the test has a range from 1-9, wherein a 1 means dislike extremely and a 9 means like extremely. A second embodiment of the present invention provides a kit comprising: an edible sweet potato composition, wherein said edible sweet potato composition has a mouthfeel in a range of preferably from about 5.1-9.0, based on a mouthfeel test, wherein the test has a range from 1-9, wherein a 1 means dislike extremely and a 9 means like extremely; and a receptacle.

### BACKGROUND OF THE INVENTION

1. Technical Field

The present invention relates to a method for preparing an edible sweet potato composition, and a kit for said edible sweet potato composition. More specifically, this invention relates to an edible sweet potato pie filling, a method of making thereof, and a kit for thereof.

2. Related Art

Flours disclosed in U. S. Pat. Nos. 4,925,697, 4,946,703, 5,244,689, 5,789,012 to Slimak prepared from communited white sweet potatoes, cassava, edible aroids, tropical yams, lotus, arrowhead, buckbean, and amaranth, are substitutes for wheat and other grains, legumes, milk, eggs, and a partial substitute for nuts. There is a need for other methods to prepare sweet potato.

### SUMMARY OF THE INVENTION

The present invention provides a method of making an edible sweet potato composition, comprising: providing a first mixture that includes sweet potato; and forming the edible sweet potato composition, having a mouthfeel in a range of preferably from about 5.1 to about 9.0, based on a mouthfeel test, wherein the test has a range from 1-9, wherein a 1 means dislike extremely and a 9 means like extremely.

A second embodiment of the present invention provides a kit comprising: an edible sweet potato composition, wherein said edible sweet potato composition has a mouthfeel in a range of preferably from about 5.1 to about 9.0, based on a mouthfeel test, wherein the test has a range from 1-9, wherein a 1 means dislike extremely and a 9 means like extremely; and a receptacle.

### BRIEF DESCRIPTION OF THE DRAWINGS

FIG. 1A depicts a front cross-sectional view of a first mixture, in accordance with the present invention;

FIG. 1B depicts a front cross-sectional view of a cooked first mixture, in accordance with the present invention;

FIG. 2 depicts a method for providing an edible sweet potato composition, in accordance with the present invention;

FIG. 3A depicts a front cross-sectional view of decanting the cooked first mixture, in accordance with the present invention;

FIG. 3B depicts FIG. 3A after decanting, in accordance with the present invention;

FIG. 4A depicts a front cross-sectional view of straining a cooked mixture that includes sweet potato, in accordance with the present invention;

FIG. 4B depicts a front cross-sectional view of a strained mixture that includes sweet potato, in accordance with the present invention;

FIG. 5 depicts a front cross-sectional view of the strained mixture of FIG. 4B and ingredients;

FIG. 6 depicts a front cross-sectional view of a kit comprising a sweet potato composition and a receptacle for said sweet potato composition, in accordance with the present invention;

FIG. 7 depicts a front cross-sectional view of a sweet potato pie composition, in accordance with the present convention; and

FIG. 8 depicts an inorganic receptacle used for containing a sweet potato composition, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of the embodiment. The features and advantages of the present invention are illustrated in detail in the accompanying drawing, wherein like reference numerals refer to like elements throughout the drawings. Although the drawings are intended to illustrate the present invention, the drawings are not necessarily drawn to scale.

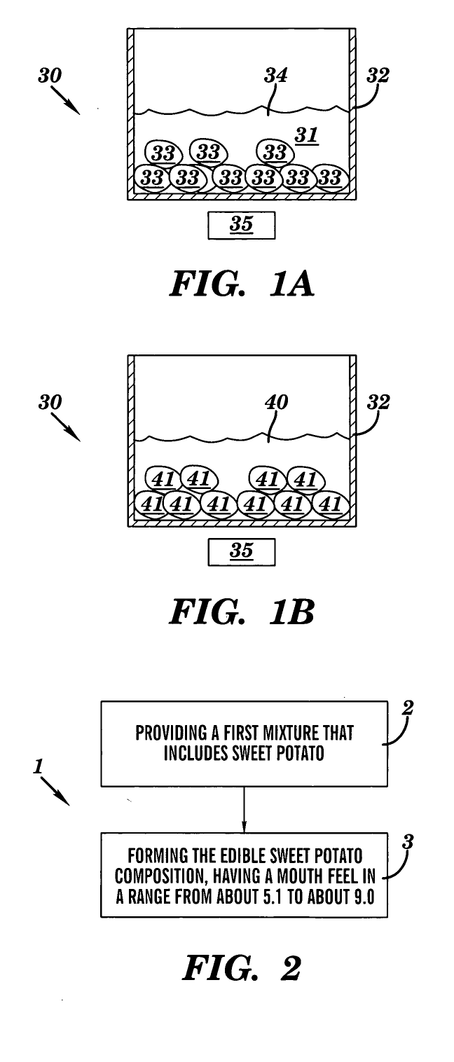

FIG. 1A depicts an apparatus 30 for preparing a first mixture 31. The apparatus 30 comprises: a vessel 32 into which may be placed washed, raw, sweet potatoes 33; water 34; and a heating element 35 from which heat is distributed to the vessel 32.

FIG. 1B depicts FIG. 1A after heating the first mixture 31, which may be heated in the range of from about 170° F. to about 212° F.

FIG. 2 depicts a method 1 of making an edible sweet potato composition, comprising: step 2, providing a first mixture that includes sweet potato; and a step 3, forming the edible sweet potato composition, having a mouthfeel in a range of preferably from about 5.1 to about 9.0.

In the food industry, the term sweet potato may refer to orange sweet potatoes, white sweet potatoes, Jersey Sweets sweet potatoes, White Delight sweet potatoes, and any potato belonging to the family of tubers known as Convolvulaceae. Hereinafter “sweet potato” refers to all potatoes belonging to the family of tubers known as Convolvulaceae.

Referring to FIG. 1A and step 2 of the method 1, washed, raw sweet potatoes 33 and water 34; may be placed in the vessel 32. In the step 3 of the method 1, the sweet potatoes 33 were cooked for a time from about 40 minutes to about 80 minutes at a temperature range of from about 170° F. to about 212° F.

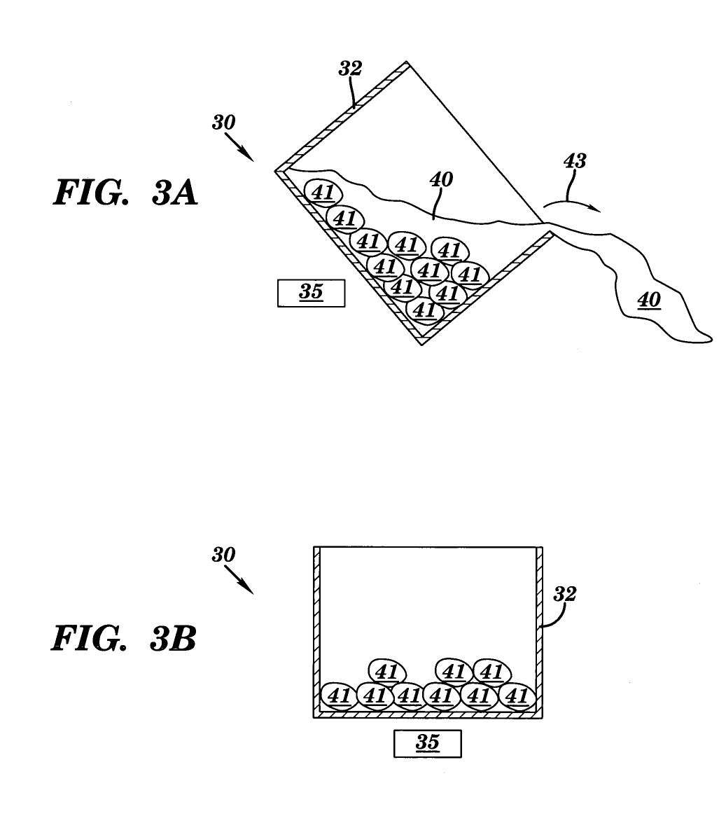

FIG. 3A depicts FIG. 1B after the water 40 was allowed to cool to ambient temperature, for from about 2 hours to about 3 hours, and decanting water 40 from the vessel 32.

FIG. 3B depicts FIG. 3A after water 40 has been decanted from the vessel 32 with the cooked sweet potatoes 41 left behind in said vessel 32.

Over cooking, such as heating the sweet potatoes 33 for longer than for a time from about 40 minutes to about 80 minutes in a temperature range of about 170° F. to about 212° F., in the forming step 3 of the method 1, results in a sweet potato composition 54 that is too soft. For example, cooking, such as heating sweet potatoes 33 for longer than 80 minutes in a temperature range from about 170° F. to about 212° F. results in the sweet potato composition 54 becoming mushy or soupy. The mouthfeel enhancers present in the sweet potatoes 33 degrade and cause a loss of structural integrity of the of sweet potato composition 54. It has been found the over cooking the sweet potato 33 results in the sweet potato composition of the present invention having an unacceptable mouthfeel, i.e. less than 5.1.

Under cooking such as heating the sweet potatoes 33 for less than a time from about 40 minutes to about 80 minutes in a temperature range of about 170° F. to about 212° F. leads to a sweet potato composition 54 that is too chunky and thick, and having a texture that will result in the sweet potato composition of the present invention having an unacceptable mouthfeel, i.e. less than 5.1.

In one embodiment, cooking the first mixture 31 in the vessel 32 in the range of about 170° F. to about 212° F. for a time from about 40 minutes to about 80 minutes, more preferably a range of about 190° F. to about 212° F., for a time from about 45 minutes to about 60 minutes, as in step 3 of the method 1, produced water 40 that includes excess mouthfeel enhancers and cooked sweet potatoes 41 with an effective concentration of mouthfeel enhancers.

Cooking the sweet potato 33 activates enzymes which subsequently transform starches present in the sweet potato 33 to alpha-starches which lead to the smooth texture and setting ability of the sweet potato compositions of the present invention. Cooking the sweet potato 33 also enhances the activity of beta-amylase present in said sweet potato 33 to increase the amount of maltose produced and to thus bring out the mellow, sweet flavor that is desired most in the sweet potato composition of the present invention.

Referring to FIG. 1A and step 2 of the method 1, it has been found that when the water mixture 31 comprises from about 12.9 percent by weight to about 26.9 percent by weight sweet potatoes 33, the sweet potato composition 70 has a smooth texture and a mellow, sweet taste. The texture and taste of the sweet potato composition can be affected by having an effective concentration of mouthfeel enhancers in the sweet potato.

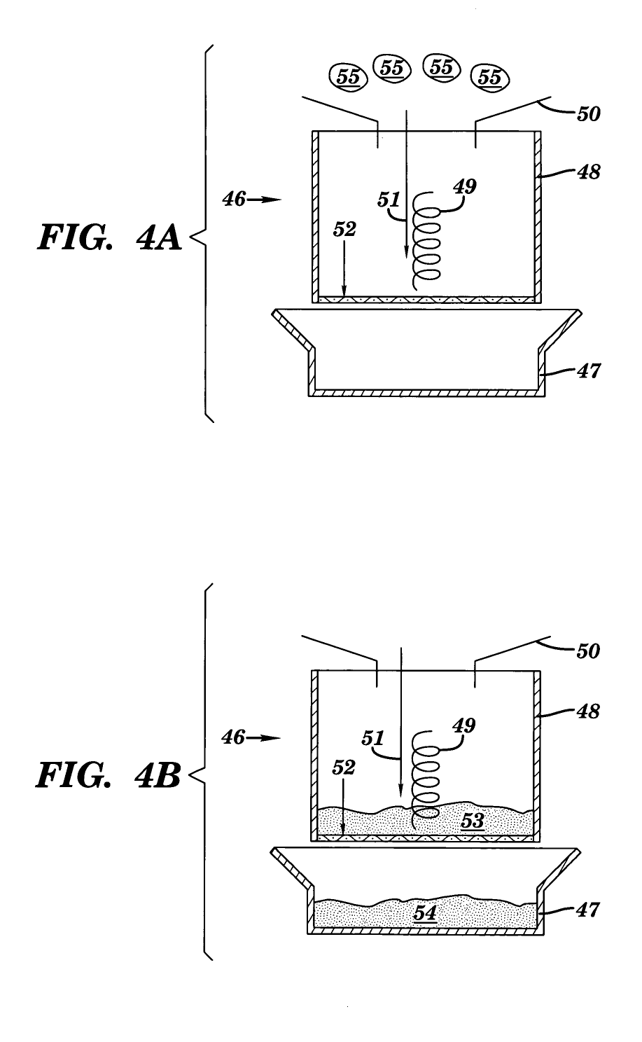

FIG. 4A depict step 3 of the method 1, a strainer 46 for straining peeled and cooked sweet potatoes 55, and a receiver 47 strainer 46 comprises: a housing 48; and an auger 49. The peeled and cooked sweet potatoes 55 are added to the strainer 46 via a funnel 50. The potatoes 55 are fed, in the direction of an arrow 51, through the funnel 50, and into the strainer housing 48. The strainer auger 49 forces the potatoes 55, in the direction of an arrow 51, through the strainer mesh 52. The strainer mesh 52 may be from about 5 inches to about 10 inches long and from about 1 inch to about 3 inches in diameter with a pore size from about ⅛ inch to about 1/16 inch.

FIG. 4B depicts a strained mixture, wherein said strained mixture comprises a second portion 54, of sweet potato. The sweet potatoes 55 of FIG. 4A are fed, in the direction of an arrow 51, through the funnel 50, and into the strainer housing 48. The strainer auger 49 forces the potatoes 33, in the direction of an arrow 51, through the strainer mesh 52. The first portion 53 is collected by and prevented from passing through the strainer mesh 52. The second portion 54 having an effective concentration of mouthfeel enhancers passes through the strainer mesh 52 and is collected by the receiver 47. It has been found that not straining the cooked sweet potatoes 55 will result in the sweet potato composition of the present invention having an unacceptable mouthfeel, i.e. less than 5.1.

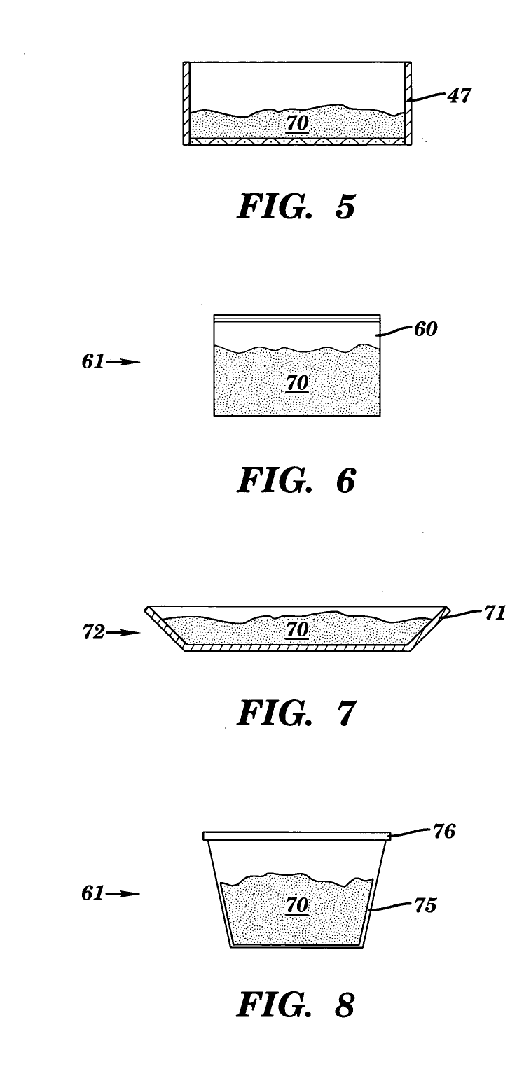

FIG. 5 depicts a receiver 47 used for forming the edible sweet potato composition 70 of the present invention. The receiver 47, may contain the second portion 54 to which is added ingredients such as milk, butter, eggs, spices, and nuts; and combinations thereof giving an edible sweet potato composition 70, having a mouthfeel in a range of preferably from about 5.1 to about 9.0; with from abut 6.2 to about 9.0 the more preferred range; and from about 7.3 to about 9.0 the most preferred range for said sweet potato composition 70. The ingredients may include from about 29.9 percent by weight to about 46.0 percent by weight sweet potato; from about 39.0 percent by weight to about 50 percent by weight sugar; from about 0.0 percent by weight to about 15.9 percent by weight milk; from about 0.0 percent by weight to about 2.4 percent by weight butter; from about 0.0 percent by weight to about 11.8 percent by weight eggs; from about 0.3 percent by weight to about 0.5 percent by weight vanilla; from about 0.0 percent by weight to about 0.5 percent by weight nutmeg; from about 0.0 percent by weight to about 2.0 percent by weight coconut; from about 0.0 percent by weight to about 0.3 percent by weight cinnamon; and combinations thereof.

FIG. 6 depicts a kit 61 comprising the sweet potato composition 70 of FIG. 5 and a receptacle 60 for containing said sweet potato composition 70.

Hereinafter “mouthfeel” refers to a texture attribute, wherein said texture attribute is a smoothness of a sweet potato composition.

Hereinafter “mouthfeel enhancers” refer to starches, enzymes, and sugars in a sweet potato as well as additives; such as dairy products, sugar, and spices, that contribute to the mouthfeel of sweet potato compositions.

Hereinafter “effective concentration of mouthfeel enhancers” means the concentration needed to achieve the texture attribute of smoothness for an edible sweet potato composition due to the concentration of mouthfeel enhancers present in said sweet potato composition. Typically, expert taste testers are able to determine in food products and dessert fillings if the texture attribute of smoothness is acceptable through a test known in the food industry as the “mouthfeel test.”

Food companies may utilize professional taste testers who have tasted sweet potato compositions, wherein the taste testers are able to distinguish the sweet potato composition mouthfeel through the mouthfeel test.

Another methodology for determining the mouthfeel of a sweet potato composition is through consumer taste tests. Consumers are given samples of a sweet potato composition and are asked to comment on the mouthfeel of said sweet potato composition. A consumer survey of a sweet potato composition's mouthfeel often gives results that are consistent with those given by professional taste testers.

A consumer survey was conducted on the sweet potato composition 70 where said consumers were asked to taste said sweet potato composition 70. The samples of sweet potato composition 70 were presented to the consumers and a ballot completed judging four categories. The categories judged were: Color, Texture, Flavor, and Overall on a scale from 1-9, as defined in Table 1:

TABLE 1

9 = like extremely
8 = like very much
7 = like moderately
6 = like slightly
5 = neither like or dislike
4 = dislike slightly
3 = dislike moderately
2 = dislike very much
1 = dislike extremely

The average of the results are listed in Table 2. It has been found that an effective concentration of mouthfeel enhancers; the transformation of said mouthfeel enhancers; and the activation of other chemicals inherent to sweet potatoes is critical to achieving an acceptable mouthfeel.

TABLE 2

| Sample | Appearance | Texture | Taste | Overall |
|---|---|---|---|---|
| 1 | 8.5 | 8.4 | 8.2 | 8.3 |
| 2 | 5.8 | 5.1 | 5.4 | 5.8 |

Standard deviation calculations of the consumer taste test results for appearance, texture, and taste were calculated. The standard deviation for texture, wherein texture is the attribute of smoothness, give three ranges where the mean value of 8.4 may lie. One standard deviation gives a range from about 7.3 to about 9.0; two standard deviations give a range from about 6.2 to about 9.0; and three standard deviations give a range from about 5.1 to about 9.0. A mouthfeel range from about 5.1 to about 9.0 is a preferred range for the sweet potato composition 70; with from about 6.2 to about 9.0 the more preferred range; and from about 7.3 to about 9.0 the most preferred range for said sweet potato composition 70.

The standard deviation for appearance, wherein appearance refers to lack of sweet potato strings present in the sweet potato composition 70, give three ranges where the mean value of 8.5 may lie. One standard deviation gives a range from about 7.4 to about 9.0; two standard deviations give a range from about 6.3 to about 9.0; and three standard deviations give a range from about 5.2 to about 9.0. A range from about 5.2 to about 9.0 is a preferred range for the appearance of the sweet potato composition 70; with from about 6.3 to about 9.0 the more preferred range; and from about 7.4 to about 9.0 the most preferred range for said appearance of said sweet potato composition 70.

The standard deviation for taste, wherein taste refers to a sweet, mellow flavor in the sweet potato composition 70, give three ranges where the mean value of 8.2 may lie. One standard deviation gives a range from about 7.0 to about 9.0; two standard deviations give a range from about 5.8 to about 9.0; and three standard deviations give a range from about 4.6 to about 9.0. A range from about 4.6 to about 9.0 is the preferred range for the taste of the sweet potato composition 70; with from abut 5.8 to about 9.0 the more preferred range; and from about 7.0 to about 9.0 the most preferred range for said taste of said sweet potato composition 70.

FIG. 7 depicts a cross-sectional view of a sweet potato pie 80 comprising the sweet potato pie composition 70 of FIG. 6 and a pie crust 71.

FIG. 8 depicts an inorganic receptacle 75 containing a sweet potato composition 70, wherein said inorganic receptacle 75 is sealed with a plastic lid 76.

The following examples are provided to further describe embodiments of the present invention, in particular, examples of a method 1 for providing a sweet potato composition 70; examples of a sweet potato composition 70; and examples of a kit 61 described herein:

### EXAMPLE

### (all % are Percent by Weight)

Referring to FIGS. 1A and 1B, and a step 2 of a method 1, from about 30 to about 35 pounds of sweet potatoes 33 were washed and added to a vessel 32. The vessel 32 was filled with water 34 such that a first mixture 31 was formed in the vessel 32 by adding said water 34, from about 6 gallons to about 10 gallons, to the sweet potatoes 33, resulting in the first mixture 31 having from about 12.9 % to about 26.9 % sweet potato and from about 73.1% water to about 87.1% percent water. The sweet potatoes 33 then were cooked for a time from about 45 minutes to about 60 minutes in a temperature range of about 190° F. to about 212° F. resulting in water 40 having an excess of mouthfeel enhancers and cooked sweet potatoes 41 having an effective concentration of mouthfeel enhancers.

When the percent by weight water 31 was greater than 73.1%, mouthfeel enhancers were extracted from the sweet potato 33 into the water 34 and washed away when the water 40 is decanted. It is the mouthfeel enhancers and the chemical transformation of said mouthfeel enhancers into different forms during the heating process that gives the sweet potato composition its characteristic taste. A negative result of an excess loss of the mouthfeel enhancers is a dramatic decrease in the mellow flavor of the sweet potato composition.

Referring to FIGS. 3A and 3B, after the water 40 of FIG. 1B was allowed to cool to ambient temperature, about 2 to about 3 hours, said water 40 was decanted from the vessel 32 leaving behind cooked sweet potatoes 41 having an effective concentration of mouthfeel enhancers.

Referring to FIG. 4, after the hulls of the cooked sweet potatoes 41 of FIG. 3B were removed, the peeled and cooked sweet potatoes 55 then were strained in accordance with the step 3 of the method 1. The sweet potatoes 55, from about 10 to about 12 pounds, are added to the strainer 46 via a funnel 50. The peeled and cooked sweet potatoes 55 pass down, in the direction of an arrow 51, through the funnel 50 and into the strainer housing 48. The strainer auger 49 is put into motion and forces the potatoes 55, in the direction of an arrow 51, through the strainer mesh 52.

The first portion 53 is collected above and by the strainer mesh 52. The second portion 54 passes through the strainer mesh 52 and is collected by the receiver 47. The aforementioned step 3, of straining the peeled and cooked sweet potatoes 55, can be repeated as many times as necessary to strain the entire batch of said peeled and cooked sweet potatoes 55.

Referring to FIG. 5, once the strained sweet potato composition 54 has been collected in a receiver 47; an edible sweet potato composition 70, having an acceptable mouthfeel, can be realized by addition of ingredients; such as milk, butter, eggs, spices, and nuts, to the receiver 47 and mixing said ingredients. An example of mixing a strained sweet potato composition 54 with ingredients to give an edible sweet potato composition 70 is given below:
Sweet Potato 26.9-36.9%;
Milk 10.9-20.9%;
Sugar 34.9%-44.9%;
Butter 1.9-2.1%;
Vanilla 0.28-0.32%; and
Eggs 5.0-15.0%.

### EXAMPLE

### (all % are Percent by Weight)

Referring to FIG. 5, examples of a sweet potato composition 70 having acceptable mouthfeel include but are not limited to:

### Example 1

Sweet Potato 39.0-49.0%;

Sugar 50.0-60.0%;

Vanilla 0.48-0.52%; and

Nutmeg 0.48-0.52%.

### Example 2

Sweet Potato 26.3-36.3%;

Milk 10.6-19.6%;

Sugar 36.1-44.1%;

Butter 1.80-2.20%;

Vanilla 0.25-0.40%;

Eggs 4.8-13.8%; and

Coconut 1.80-3.20%.

### Example 3

Sweet Potato 26.2-36.2%

Milk 10.6-20.6%;

Sugar 34.0-44.0%;

Butter 1.0-2.5%;

Vanilla 0.30-0.40%;

Eggs 4.3-14.7%;

Nutmeg 0.30-0.40%; and

Coconut 1.5-2.5%.

### Example 4

Sweet Potato 26.8-36.8%;

Milk 10.9-20.9%;

Sugar 34.8% -44.8%;

Butter 1.5-3.5%;

Vanilla 0.25-0.35%;

Eggs 4.9-14.9%; and

Cinnamon 0.25-0.35%.

### Example 5

Sweet Potato 34.0-44.0%;

Sugar 43.4-52.4%;

Butter 1.4-3.4%;

Vanilla 0.35-0.45%; and

Eggs 6.8-16.8%.

### Example 6

Sweet Potato 32.7-42.7%;

Sugar 42.0-52.0%;

Butter 1.4-3.4%;

Vanilla 0.30-0.40%;

Eggs 7.7-17.7%;

Vanilla 0.35-0.45%;

Nutmeg 0.35-0.45%; and

Cinnamon 0.35-0.45%.

skilled in the art of cooking include but are not limited to rum, orange, and almond.

Walnuts are one example of a broad class of nuts that can be used in sweet potato compositions 70, in percentages from about 1.0 percent by weight to about 5.0 percent by weight. Examples of other nuts that can be used in a sweet potato composition 70 by one skilled in the art of cooking include but are not limited to pecans, peanuts, macadamia, and almonds.

Cinnamon is one example of a broad class of spices that can be used in a sweet potato composition 70, in percentages from about 0.3 percent by weight to about 0.5 percent by weight. Examples of other spices that can be used as substitutes for cinnamon by one skilled in the art of cooking include but are not limited to basil, thyme, sage, and tarragon.

Confectionary desserts is a broad class of desserts that can be used in a sweet potato composition 70, in percentages from about 1.0 percent by weight to about 5.0 percent by weight. Examples of other confectionary desserts that can be used as ingredients for sweet potato compositions 70 by one skilled in the art of cooking include but are not limited to marshmallow, rock candy, soft taffy, licorice, and icings.

### EXAMPLE

### (all % are Percent by Weight)

Referring to FIGS. 5 and 6, one embodiment of the kit 61, from about 1 cup to about 4 cups of sweet potato composition 70 are placed in a receptacle 60. The receptacle 60 then is sealed and frozen at a temperature from about −10° F. to about 32° F. for future use. The receptacle 60 may consist of an edible or an inorganic material.

Hereinafter an “edible receptacle” refers to a container that consists of dough, bread, bread crust, and any bread product; a container that can be consumed by a person; a container that can be filled with the sweet potato composition 70 and hold said sweet potato composition 70; and combinations thereof. Examples include but are not limited to pre-made pie crusts, pie crusts made from scratch, dough, pirogi shells, pita bread shells, pasta shells, and bell peppers. The edible receptacle may take the shape of a lentoid, an oblate spheroid, a prolate spheroid, an obconic frustum of a right circular cone or a cotyloid; and combinations thereof. Examples include but are not limited generally deep-dished pie shapes, coffee cup shapes, ravioli shapes, pirogi shapes, and doughnut shapes.

Hereinafter an “inorganic receptacle” refers to a container that consists of plastic, cellophane, aluminum foil, and Styrofoam; a container that can not consumed by a person; a container that can be filled with a sweet potato composition 70 and hold said sweet potato composition 70; and combinations thereof. The inorganic receptacle may take the shape of a lentoid, an oblate spheroid, a prolate spheroid, an obconic frustum of a right circular cone or a cotyloid; and combinations thereof. Examples include but are not limited generally deep-dished pie shapes, coffee cup shapes, ravioli shapes, pirogi shapes, and doughnut shapes.

The following examples are provided to further describe embodiments of the present invention, in particular, examples of kits comprising sweet potato compositions 70 having an acceptable mouthfeel; and a receptacle described herein.

Referring to FIGS. 5-7, one embodiment of the kit 61, from about 1 cup to about 4 cups of sweet potato composition 70 are placed in an edible receptacle 60 by means known to one skilled in the art of cooking food products. The edible receptacle in this example is a pre-made pie crust 71. The pie crust 71 containing the sweet potato composition 70 was baked at a temperature of about 370° F. to about 380° F. for a time from about 15 minutes to about 20 minutes or until golden brown giving a sweet potato pie 72.

Referring to FIGS. 5-6, another embodiment of the kit 61, from about 1 cup to about 4 cups of sweet potato composition 70 are placed in an edible receptacle 60 by means known to those skilled in the art of cooking food products. The edible receptacle in this example is a pirogi type pouch made of bread dough. The pouch containing the sweet potato composition 70 was baked at a temperature from about 345° F. to about 365° F. for a time from about 30 minutes to about 40 minutes or until golden brown.

In the above examples, the edible receptacle 60 was a pre-made pie crust 71 and a pirogi type pouch. Both the pre-made pie crust 71 and the pouch can be substituted with other edible receptacles 60 such as ravioli shells, pita bread, pasta shells, and bell peppers by one skilled in the art of cooking.

Referring to FIGS. 5 and 8, one embodiment of the kit 61, from about 1 cup to about 4 cups of sweet potato composition 70 are placed in an inorganic receptacle 60 by means known to one skilled in the art of cooking. The sweet potato composition 70 may comprise from about 29.9 percent by weight to about 46.0 percent by weight sweet potato; from about 39.0 percent by weight to about 50 percent by weight sugar; from about 0.0 percent by weight to about 15.9 percent by weight milk; from about 0.0 percent by weight to about 2.4 percent by weight butter; from about 0.0 percent by weight to about 11.8 percent by weight eggs; from about 0.3 percent by weight to about 0.5 percent by weight vanilla; from about 0.0 percent by weight to about 0.5 percent by weight nutmeg; from about 0.0 percent by weight to about 2.0 percent by weight coconut; from about 0.0 percent by weight to about 0.3 percent by weight cinnamon; and combinations thereof.

In another example, the sweet potato composition 70 may comprise from about 29.9 percent by weight to about 46.0 percent by weight sweet potato; from about 0.3 percent by weight to about 50 percent by weight spices; from about 0.0 percent by weight to about 15.9 percent by weight milk; from about 0.0 percent by weight to about 2.4 percent by weight butter; from about 0.0 percent by weight to about 11.8 percent by weight eggs; from about 0.0 percent by weight to about 2.0 percent by weight nuts; and combinations thereof.

The inorganic receptacle in this example is a Styrofoam cup 75. The Styrofoam cup 75 containing said sweet potato composition 70 is sealed with a plastic lid 76 and then frozen at temperature range from about −10° F. to about 32° F. for future use. The sweet potato composition 70 can be kept at a temperature range from −10° F. to about 32° F. for from about 3 months to about 8 months without any spoilage of said sweet potato composition 70. The frozen sweet potato composition can be thawed, cooked, and consumed at the convenience of a user.

Thawing of the sweet potato composition 70 can be achieved by warming said sweet potato composition 70 in warm water, low microwave cooking, or by means known to those skilled in the art of cooking. The thawed sweet potato composition then can be transferred to an edible receptacle 60 by means known to those skilled in the art of cooking and baked for a time from about 15 minutes to about 20 minutes at a temperature of about 345° F. to about 3800 F or until golden brown. Cooking by the aforementioned process gives a sweet potato composition that is ready for immediate consumption. Examples of an edible receptacle 60 are pre-made pie crusts, pie crusts made from scratch, dough, pirogi shells, pita bread shells, pasta shells, and bell peppers as well as edible containers known to one skilled in the art.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included withing the scope of this invention as defined by the accompanying claims.

1. A method of making an edible sweet potato composition, comprising:
providing a first mixture that includes sweet potato; and
forming the edible sweet potato composition, having a mouthfeel in a range from about 5.1 to about 9.0, based on a mouthfeel test, wherein the test has a range from 1-9, wherein a 1 means dislike extremely and a 9 means like extremely.

2. The method of claim 1, wherein the first mixture comprises from about 12.9 percent by weight to about 26.9 percent by weight sweet potato and from about 73.1 percent by weight to about 87.1 percent by weight water.

3. The method of claim 1, wherein the forming step includes cooking the first mixture, and wherein the sweet potato has an effective concentration of mouthfeel enhancers.

4. The method of claim 3, wherein cooking the first mixture includes boiling said first mixture for a time from about 40 minutes to about 80 minutes.

5. The method of claim 3, wherein when about 12.9 percent by weight to about 26.9 percent by weight of sweet potato is cooked in about 73.1 percent weight to about 87.1 percent weight of water for a time from about 45 minutes to about 60 minutes at a temperature of about 190° F. to about 212° F., a cooked sweet potato has the effective concentration of mouthfeel enhancers.

6. The method of claim 3, wherein cooking the first mixture enhances the activity of beta-amylase present in said sweet potato.

7. The method of claim 1, wherein the forming step includes straining the cooked sweet potato; wherein a first portion of the cooked sweet potato remains above the strainer and a second portion of the cooked sweet potato having the effective concentration of mouthfeel enhancers is collected in a receiver.

8. The method of claim 1, further comprising after the forming step, baking the edible sweet potato composition in a pie crust at temperature of from about 345° F. to about 360° F. for a time from about 30 minutes to about 40 minutes giving an edible sweet potato pie.

9. A kit comprising:
an edible sweet potato composition in a bell pepper.

10. The composition of claim 9, wherein the edible composition has an appearance in a range from about 5.2 to about 9.0, based on a mouthfeel test, wherein the test has a range from 1-9, wherein a 1 means dislike extremely and a 9 means like extremely.

11. The composition of claim 9, wherein the edible composition has a taste in a range of from about 4.6 to about 9.0, based on a mouthfeel test, wherein the test has a range from 1-9, wherein a 1 means dislike extremely and a 9 means like extremely.

12. A kit comprising:
an edible sweet potato composition, having a mouthfeel in a range from about 5.1 to about 9.0, based on a mouthfeel test, wherein the test has a range from 1-9, wherein a 1 means dislike extremely and a 9 means like extremely; and a receptacle.

13. The kit of claim 12, wherein the edible composition comprises: from about 29.9 percent by weight to about 46.0 percent by weight sweet potato; from about 39.0 percent by weight to about 50 percent by weight sugar; from about 0.0 percent by weight to about 15.9 percent by weight milk; from about 0.0 percent by weight to about 2.4 percent by weight butter; from about 0.0 percent by weight to about 11.8 percent by weight eggs; from about 0.3 percent by weight to about 0.5 percent by weight vanilla; from about 0.0 percent by weight to about 0.5 percent by weight nutmeg; from about 0.0 percent by weight to about 2.0 percent by weight coconut; from about 0.0 percent by weight to about 0.3 percent by weight cinnamon; and combinations thereof.

14. The kit of claim 12, wherein the edible composition comprise: from about 29.9 percent by weight to about 46.0 percent by weight sweet potato; from about 0.3 percent by weight to about 50 percent by weight spices; from about 0.0 percent by weight to about 15.9 percent by weight milk; from about 0.0 percent by weight to about 2.4 percent by weight butter; from about 0.0 percent by weight to about 11.8 percent by weight eggs; from about 0.0 percent by weight to about 2.0 percent by weight nuts; and combinations thereof.

15. The kit of claim 12, wherein the receptacle is an edible vessel.

16. The kit of claim 15, wherein the edible vessel may consist of dough, bread, bread crust, or any bread product and combinations thereof.

17. The kit of claim 15, wherein the edible vessel is in the form of a lentoid, an oblate spheroid, a prolate spheroid, an obconic frustum of a right circular cone or a cotyloid; and combinations thereof.

18. The kit of claim 12, wherein the container is an inorganic package.

19. The kit of claim 118, wherein a inorganic package material my comprise of plastic, cellophane, aluminum foil, or Styrofoam; and combinations thereof.

20. The kit of claim 18, wherein the inorganic package is in the form of a lentoid, an oblate spheroid, a prolate spheroid, an obconic frustum of right circular cone or a cotyloid; and combinations thereof.
